(19) United States
(12) Patent Application Publication
(10) Pub. No.: US 2010/0049692 A1
(43) Pub. Date: Feb. 25, 2010

(54) Apparatus and Method For Retrieving Information From An Application Functionality Table

(75) Inventors: Abdellatif Astito, Velizy-Villacoublay (FR); Maxime Belhoste, Asnieres sur Seine (FR); Lucile Claude, Soucy (FR); Francois Llirbat, Bagnolet (FR); Frederic Vanborre, Rueil Malmaison (FR); Pierpaolo Vezzosi, Paris (FR)

Correspondence Address: SAP Global IP c/o Cooley Godward Kronish LLP;William S. Galliani, 777 6th Street NW, Suite 1100, Washington, DC, 20001, US

(73) Assignee: BUSINESS OBJECTS, S.A., Levallois-Perret (FR)

(21) Appl. No.: 12/196,007

(22) Filed: Aug. 21, 2008

(51) Int. Cl. G06F 17/30

(52) U.S. Cl. 707/2; 707/E17.045; 707/E17.014

(57) ABSTRACT

A computer readable storage medium includes executable instructions to derive a table representing operations associated with an application. One or more parameters are received. A query is executed against the table if the parameters are resolvable with respect to one or more columns in the table. A derived query is constructed based on one or more additional parameters if the parameters are not resolvable with respect to one or more columns in the table. The derived query is executed against the table. A query result is returned.

### FIELD OF THE INVENTION

The invention relates generally to computer implemented processing of information requests. More particularly, the invention relates to a technique for processing information requests against a data structure in a relational data source that serves as the interface to an application.

### BACKGROUND OF THE INVENTION

An application includes a collection of computer programs and associated files that perform an integrated set of functions for a user. For example, a weather report application may be used to retrieve information about the temperature in a particular city. Applications are typically accessible to end users via a user-interface through which users can request specific information associated with the application.

Data in relational databases is contained in tables. A table is a set of data arranged in columns identified by name of data type and horizontal rows. A table shares many properties with a relation which is an alternative way of representing relational data. The rows in a table are tuples in a relation and both can be called records. Each tuple has one or more components identified by its order in the tuple. Each component corresponds to a column. Queries to tables and relations are flexible. A query can specify exact records by providing a key or set of records corresponding to logical predicates with column names as variables. This query interface has utility in many computing environments.

It would be advantageous to develop a technique by which the structure and functionality of an application can be represented in a generic manner so that information requests can be made by way of a query. With such techniques requests for information should be flexibly placed while processed efficiently and accurately.

### SUMMARY OF THE INVENTION

The invention includes a computer readable storage medium with executable instructions to derive a table representing operations associated with an application. One or more parameters are received. A query is executed against the table if the parameters are resolvable with respect to one or more columns in the table. A derived query is constructed based on one or more additional parameters if the parameters are not resolvable with respect to one or more columns in the table. The derived query is executed against the table. A query result is returned.

The invention includes a computer readable storage medium with executable instructions to create a table including a set of input columns and a set of output columns. A record in the table represents a set of inputs to an application and the corresponding outputs. When a parameter that is part of a query is received and the parameter cannot be resolved then a derived query for a set of output values is constructed. The derived query is based on the set of inputs including the parameters which is not resolvable with respect to the table. A request is made for the derived query to be executed and the derived query's result is received.

### BRIEF DESCRIPTION OF THE FIGURES

The invention is more fully appreciated in connection with the following detailed description taken in conjunction with the accompanying drawings, in which:

FIG. 1 illustrates a computer configured in accordance with one embodiment of the present invention.

FIG. 2 is a diagrammatic illustration of the technique of representing the functionality of an application as a table, in accordance with one embodiment of the present invention.

FIG. 3 is a flowchart illustrating exemplary operations for processing an information requests in accordance with one embodiment of the present invention.

Like reference numerals refer to corresponding parts throughout the several views of the drawings.

### DETAILED DESCRIPTION OF THE INVENTION

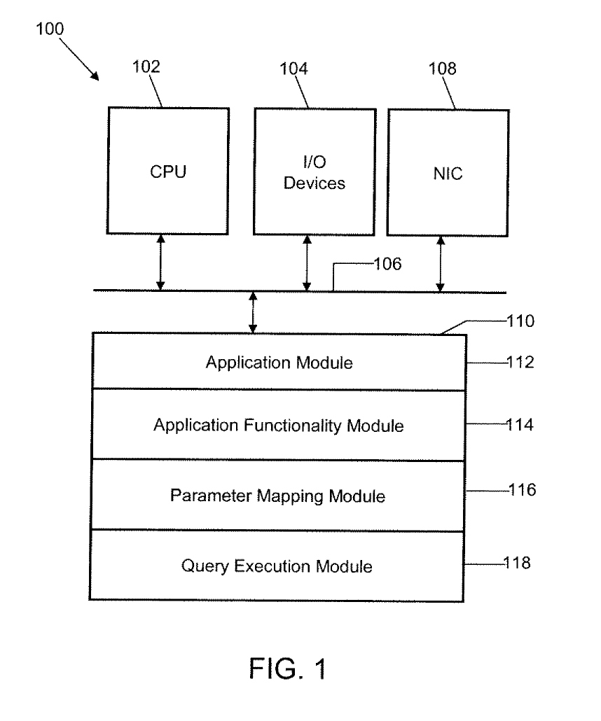

FIG. 1 illustrates a computer configured in accordance with one embodiment of the present invention. The computer 100 includes standard components, including a Central Processing Unit (CPU) 10) and input/output devices 104, which are linked by a bus 106. A Network Interface Circuit (NIC) 108 provides connectivity to a network (not shown), thereby allowing the computer 100 to operate in a networked environment. A memory 110 is also connected to the bus 106. The memory 110 includes executable instructions to implement operations of the invention.

In the example shown in FIG. 1, the memory 110 includes an Application Module 112, an Application Functionality Module 114, a Parameter Mapping Module 116 and a Query Execution Module 118. The Application Module 112 includes one or more applications that may be accessed either locally on the computer 100 or remotely Via a network. The applications include a set of computer programs and associated data files that perform an integrated set of functions for a user and enable the user to accomplish specific tasks. For example, the applications may include one or more programs configured to retrieve financial information associated With a particular corporation or provide information about the weather within a particular city.

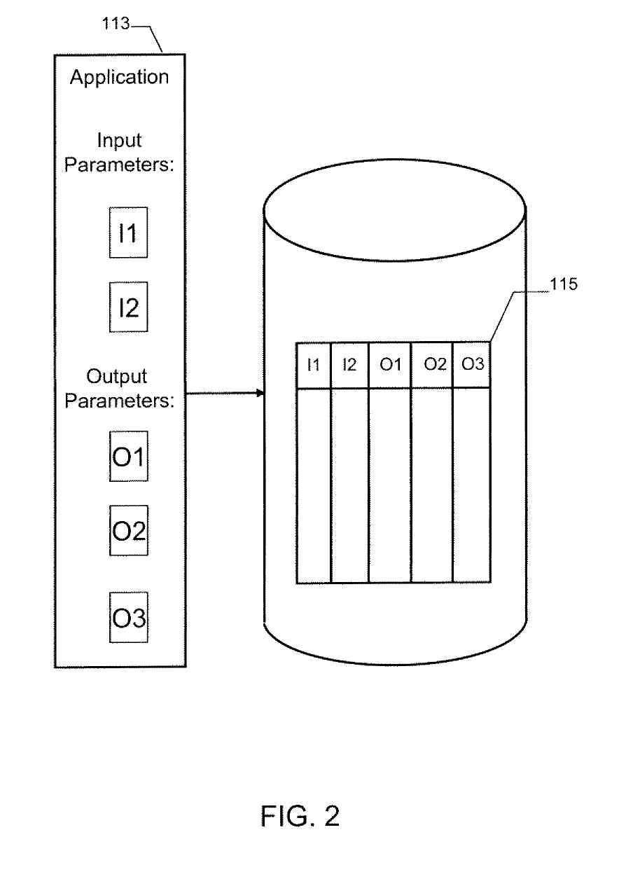

The Application Functionality Module 114 includes executable instructions to represent the functionality of an application in the Application Module 112 as a table FIG. 2 is a diagrammatic illustration of the technique of representing the functionality of an application as a table, in accordance with one embodiment of the present invention. As illustrated, in one embodiment, the Application Functionality Module 114 derives a table 115 including input columns, I1 and I2 and output columns O1, O2 ad O3 representing operations associated with an application 113. An input column is a column used to store and represent an input parameter for an application. An output column does the same for output parameters. The application 113 includes input parameters I1 and I2 and output parameters O1, O2 and O3.

The Parameter Mapping Module 116 includes executable instructions to receive parameters from a user accessing an application in the Application module 112. In one embodiment, the Parameter Mapping Module 116 includes executable instructions to map the parameters to the columns in the table derived by the Application Functionality Module 114. Specifically, the Parameter Mapping Module 116 includes executable instructions to map the parameters to columns in the table. This mapping may be expressed in different ways. For example as a query, such as a Structured Query Language (SQL) query. The Query Execution Module 118 executes the query against the columns in the table to return a query result. In an embodiment, the mapping is represented in data structures such as a map, a permutation matrix, a graph, a table, or the like.

The executable modules stored in memory 110 are exemplary. Additional modules, such as an operating system or graphical user interface module may also be included. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and or server-side. It is the functions of the invention that are significant, not where they are performed or the specific manner in which they are performed.

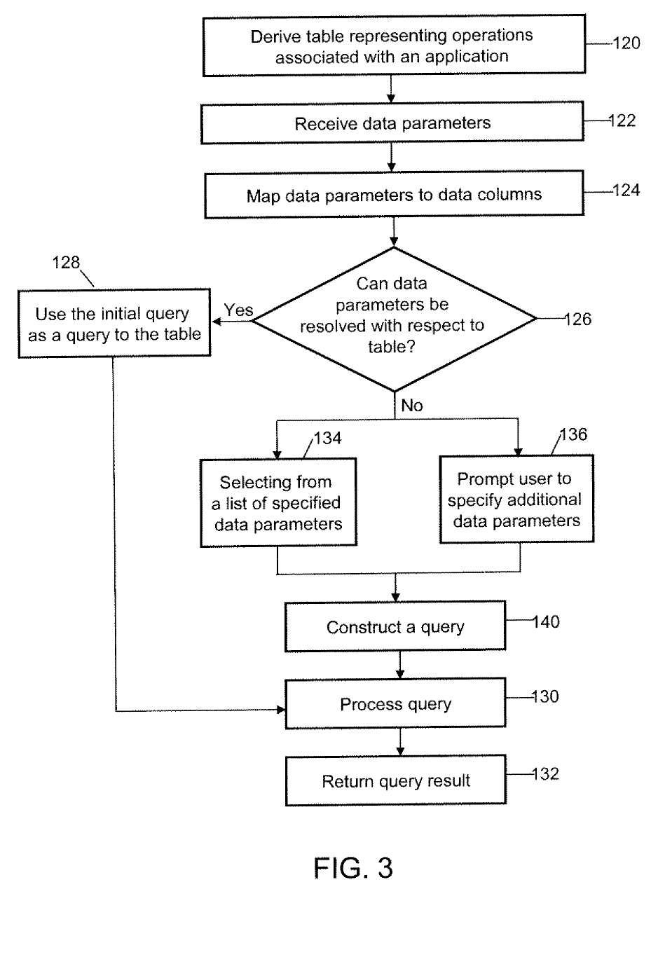

FIG. 3 is a flowchart illustrating exemplary operations for processing a query in accordance with one embodiment of the present invention. As discussed above, the Application Functionality Module 114 includes executable instructions to derive a table representing operations associated with an application 120. As an example, consider a stock application that receives as input data a stock symbol and returns as output data the value of the stock in real time. An application functionality table derived by the Application Functionality Module 114 can include a “stock” table with a “stock symbol” input column and a “stock value” output column. The Parameter Mapping Module 116 includes executable instructions to receive parameters 122 (e.g., parameters that form a portion of a query) from a user accessing the application and map the parameters to one or more columns in the table 124. For example, the Parameter Mapping Module 116 can receive a parameter specifying the retrieval of information about a particular stock symbol. In one embodiment, the Parameter Mapping Module 116 can receive an initial query produced by a semantic layer. A semantic layer can be regarded as a data foundation overlying a data source associating common terms with columns names.

A check is made by the Parameter Mapping Module 116 to determine if the mapped parameters can be resolved with respect to the columns in the table 126. A failure to resolve means a parameter value can't be attached to an input column. This occurs for a variety of reasons. Because the query interface to the table is a normal query interface the input columns are not subject to special query restrictions. Any query to the table is not forbidden for reason of not specifying an input parameter value so as long as the query is syntactically valid. However, problems arise upon execution of a query not specifying one or more input parameters. Specifically, the table is queried for all outputs for the entire range of input parameter values. Hence, the Parameter Mapping Module 116 determines if the mapped parameters can be resolved. If so, 126—Yes, the Parameter Mapping Module 116 selects for use an initial query specifying the columns in the table that correspond to the mapped parameters 128. For example, the Parameter Mapping Module 116 can use a query specifying the “stock symbol” input column in the table derived by the Application Functionality Module 114.

In another embodiment, the Parameter Mapping Module 116 can select a dynamically generated query for execution. The Query Execution Module 118 then executes the query against the columns in the table 130, and returns a query result 132. For example, the Query Execution Module 118 can execute the selected query against the “stock symbol” input column and return the corresponding stock value as a query result. In one embodiment, the query executed by the Query Execution Module 118 is a Structured Query Language (SQL) statement.

Continuing with the example of the stock application, suppose the Parameter Mapping Module 116 receives a parameter that does not specify the retrieval of information about a particular stock symbol, The Parameter Mapping Module 116 then determines at 126 that the parameters cannot be resolved with respect to the columns in the table. Examples of situations that include a failure to resolve a parameter for the table include when the query to the table specifies a right outer join on the table. Other examples are where a value is omitted for the input parameter. In this case, 126—No, the Parameter Mapping Module 116 includes executable instructions to obtain additional parameters to resolve the query. This list will be defined prior to query run time. In an embodiment, a list of parameters may be programmatically assigned to resolve the query 134. The list of parameters may be static or dynamic. A static list may be hard-coded parameters. A dynamic list of parameters may be implemented by placing the list in another database table. In another embodiment, the user is prompted to specify the additional parameters 136. This prompt may be for entering text. It may include a list of parameter values for the user to select from. Such a list may be static or dynamic.

The Parameter Mapping Module 116 then constructs a query based on the additional parameters 140. For example, in one embodiment, the Parameter Mapping Module 116 may prompt a user to enter particular stock symbols for which corresponding stock values have to be retrieved. In another embodiment, the Parameter Mapping Module 116 may provide a hard-coded list of specific stock symbols to the application. In yet another embodiment, the Parameter Mapping Module 116 may assign a dynamic list of parameters by analyzing the columns in one or more related tables in the Application Functionality Module 114 to extract one or more particular stock symbols and their corresponding stock values. The Query Execution Module 118 then executes the query against the columns in the table 130 and returns a query result 132. As will be appreciated, the additional parameters used to construct the query enable the generation of a default binding value for the columns in the table thereby ensuring the accurate processing of the query to return a valid query result.

Those skilled in the art will recognize a number of advantages associated with the disclosed technology. First, the disclosed application functionality table enables the representation of the functionality of an application as a table representing operations associated with an application. Second, the disclosed technology enables the efficient and accurate processing of queries against the application functionality table. Further, by generating default binding values for the columns in the query, the disclosed technology ensures that a request from a user is always processed accurately to return a valid and predictable result.

An embodiment of the present invention relates to a computer storage product with a computer readable medium having computer code thereon for performing various computer implemented operations. The computer readable storage medium and computer code may be those specially designed and constructed for the purposes of the present invention, or they may be of the kind well known and available to those having skill in the computer software arts. Examples of computer readable storage media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium comprising executable instructions to:
derive a table representing operations associated with an application;
receive one or more parameters;
execute a query against the table if the parameters are resolvable with respect to one or more columns in the table;
construct, as a query against the table, a derived query based on the one or more additional parameters if the parameters are not resolvable with respect to one or more columns in the table;
execute the query against the table; and
return a query result.

2. The computer readable storage medium of claim 1, wherein the parameters comprise at least one of an input parameter and an output parameter to the application.

3. The computer readable storage medium of claim 1, wherein the columns in the table include at least one of an input column and an output column.

4. The computer readable storage medium of claim 1, further comprising executable instructions to map the parameters to the columns in the table to generated mapped parameters.

5. The computer readable storage medium of claim 4, further comprising executable instructions to select a query specifying the columns in the table that correspond to the mapped parameters.

6. The computer readable storage medium of claim 1, wherein the executable instructions to construct a derived query further comprise executable instructions to prompt a user to specify the additional parameters.

7. The computer readable storage medium of claim 1, wherein the executable instructions to construct a derived query further comprise executable instructions to specify a list of hard-coded parameters to resolve the query.

8. The computer readable storage medium of claim 1, wherein the executable instructions to construct a derived query further comprise executable instructions to assign a dynamic list of parameters to resolve the query.

9. The computer readable storage medium of claim 1, wherein the query is a Structured Query Language (SQL) statement.

10. A computer readable storage medium comprising executable instructions to:
create a table including a set of input columns and a set of output columns, wherein a record in the table represents a set of inputs and a set of corresponding outputs to an application;
receive an initial query with a parameter that is not resolvable with respect to the table;
construct a derived query for a set of output values based on the set of inputs including the parameter which is not resolvable with respect to the table;
request execution of the derived query against the table; and
receive a query result.

11. The computer readable storage medium of claim 10, wherein the table comprises an interface to the application.

12. The computer readable storage medium of claim 11, wherein the interface to the application is accessed by using Structured Query Language (SQL) statement.

13. The computer readable storage medium of claim 1, wherein the initial query is produced by a semantic layer.
